(19) United States
(12) Patent Application Publication
(10) Pub. No.: US 2006/0055845 A1
(43) Pub. Date: Mar. 16, 2006

(54) Liquid crystal display device

(76) Inventor: Yuzo Hisatake, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/033,401

(22) Filed: Jan. 12, 2005

Related U.S. Application Data
(63) Continuation of application No. PCT/JP04/13555, filed on Sep. 16, 2004.

(51) Int. Cl. G02F 1/1335

(52) U.S. Cl. 349/98

(57) ABSTRACT

A circular-polarization-based mode LCD includes, in the named order, a light source a circular polarizer structure including a first polarizer plate and a first phase plate, a variable retarder structure including a liquid crystal cell, and a circular analyzer structure including a second polarizer plate and a second phase plate. Each of the first phase plate and the second phase plate is a uniaxial ¼ wavelength plate. A third phase plate that has a refractive index anisotropy of nx>ny=nz is disposed between the first polarizer plate and the first phase plate such that a slow axis thereof is set to be substantially parallel to a transmission axis of the first polarizer plate. A fourth phase plate that has a refractive index anisotropy of nx=ny>nz is disposed between the liquid crystal cell and the first polarizer plate or the second phase plate.

### CROSS-REFERENCE TO RELATED APPLICATIONS

This is a Continuation Application of PCT Application No. PCT/JP2004/013555, filed Sep. 16, 2004, which was not published under PCT Article 21(2) in English.

### BACKGROUND OF THE INVENTION

1. Field of the Invention

The present invention relates to a liquid crystal display device, and more particular to a circular-polarization-based vertical-alignment-mode liquid crystal display device.

2. Description of the Related Art

A liquid crystal display device has various features such as thickness in size, light weight, and low power consumption. The liquid crystal display device is applied to various uses, e.g. OA equipment, information terminals, timepieces, and TVs. In particular, a liquid crystal display device comprising thin-film transistors (TFTs) has high responsivity and, therefore, it is used as a monitor of a mobile TV, a computer, etc., which displays a great deal of information.

In recent years, with an increase in quantity of information, there has been a strong demand for higher image definition and higher display speed. Of these, the higher image definition is realized, for example, by making finer the array structure of the TFTs.

On the other hand, in order to increase the display speed, consideration has been given to, in place of conventional display modes, an OCB (Optically Compensated Birefringence) mode, a VAN (Vertically Aligned Nematic) mode, a HAN (Hybrid Aligned Nematic) mode and a π alignment mode, which use nematic liquid crystals, and an SSFLC (Surface-Stabilized Ferroelectric Liquid Crystal) mode and an AFLC (Anti-Ferroelectric Liquid Crystal) mode, which use smectic liquid crystals.

Of these display modes, the VAN mode, in particular, has a higher response speed than in the conventional TN (Twisted Nematic) mode. An additional feature of the VAN mode is that a rubbing process, which may lead to a defect such as an electrostatic breakage, can be made needless by vertical alignment. Particular attention is drawn to a multi-domain VAN mode (hereinafter referred to as “MVA mode”) in which a viewing angle can be increased relatively easily.

In the MVA mode, for example, mask rubbing and pixel electrode structures are devised, or a protrusion is provided within a pixel. Thereby, the inclination of an electric field, which is applied to the pixel region, from the pixel electrode and counter-electrode, is controlled. The pixel region of the liquid crystal layer is divided into, e.g. four domains such that the orientation directions of liquid crystal molecules are inclined at 90° to each other in a voltage-on state. This realizes improvement in symmetry of viewing angle characteristics and suppression of an inversion phenomenon.

In addition, a negative phase plate is used to compensate the viewing angle dependency of the phase difference of the liquid crystal layer in the state in which the liquid crystal molecules are oriented substantially vertical to the major surface of the substrate, that is, in the state of black display. Thereby, the contrast (CR) that depends on the viewing angle is improved. Besides, more excellent viewing angle/contrast characteristics can be realized in the case where the negative phase plate is a biaxial phase plate having such an in-plane phase difference as to compensate the viewing angle dependency of the polarizer plate, too.

In the conventional MVA mode, however, since each pixel has a multi-domain structure, a region, where liquid crystals are oriented in a direction other than a desirable direction, is formed. For example, liquid crystals are schlieren-oriented or orientated in an unintentional direction, at a boundary of the divided domains, at a protrusion in the multi-domain pixel, or near a pixel electrode slit.

The transmittance Tlp(LC) of a liquid crystal layer, under crossed Nicols, of a liquid crystal display device, which uses a linear polarizer plate and executes a linear-polarization-based birefringence control, is expressed by

$$Tlp ( LC ) = {I}_{0} \cdot {sin}^{2} ( 2 θ ) \cdot {sin}^{2} ( \frac{Δ n ( λ , V ) \cdot d}{λ} π ) \qquad ( 1 )$$

In equation (1), I₀ is the transmittance of linearly polarized light that is parallel to the transmission axis of the polarizer plate, θ is the angle between the slow axis of the liquid crystal layer and the optical axis of the polarizer plate, V is a voltage applied, d is the thickness of the liquid crystal layer, and λ is the wavelength of incident light to the liquid crystal display device.

In equation (1), the refractive index anisotropy Δn(λ,V) depends on an effective application voltage in the region and the inclination angle of each nematic liquid crystal molecule. In order to vary T(LC) to 0 to I₀, it is necessary to vary Δn(λ,V)d/λ in a range of 0 to λ/2 and to set the value of θ at π/4(rad). Consequently, in the region where the liquid crystal molecules are oriented in a direction other than π/4, the transmittance decreases. As mentioned above, in the MVA mode, the multi-domain structure is adopted and thus such a region is necessarily formed. Hence, in the MVA mode, a problem, such as low transmittance, occurs, compared to the TN mode.

In order to overcome this problem, a circular-polarization-based MVA mode has currently been considered. The above problem is solved by replacing the linear polarizer plate with a circular polarizer plate, which has a phase plate, that is, a uniaxial ¼ wavelength plate that provides a phase difference of a ¼ wavelength between light rays of predetermined wavelengths that travel along the fast axis and slow axis. The transmittance Tcp(LC) of a liquid crystal layer, under crossed Nicols, of a liquid crystal display device, which uses a circular polarizer plate and executes a circular-polarization-based birefringence control, is expressed by

$$Tcp ( LC ) = {I}_{0} \cdot {sin}^{2} ( \frac{Δ n ( λ , V ) \cdot d}{λ} π ) \qquad ( 2 )$$

As is understood from equation (2), the transmittance Tcp(LC) does not depend on the orientation direction of liquid crystal molecules. Thus, a desired transmittance can be obtained only if the inclination of liquid crystal molecules can be controlled, despite the formation of a region where liquid crystals are oriented in a direction other than a desirable direction, for example, a region where liquid crystals are schlieren-oriented or orientated in an unintentional direction at a boundary of the divided domains and near the multi-domain structure

The prior-art circular-polarization-based MVA mode, however, there is such a problem that the viewing angle characteristic range is narrow.

FIG. 9 shows an example of the cross-sectional structure of a prior-art liquid crystal display device of a circular-polarization-based MVA mode. As is shown in FIG. 9, a first substrate 13 has a common electrode 9 of ITO (indium tin oxide) on an inner surface thereof. The common electrode 9 is provided with a protrusion 12 for forming a multi-domain structure within a pixel. A second substrate 14, which is opposed to the first substrate 13, has a pixel electrode 10 of ITO on an inner surface thereof. The second substrate 14 has slits 11 (where no pixel electrode is provided) for forming the multi-domain structure within the pixel. A nematic liquid crystal 7 with negative dielectric anisotropy is sandwiched between the common electrode 9 and pixel electrode 10. An orientation process is executed such that liquid crystal molecules 8 are aligned substantially vertical to the major surface of the substrate in a voltage-off state.

The liquid crystal cell with the above structure includes phase plates 3 and 4 and polarizer plates 5 and 6, which are provided on both outer surfaces of the liquid crystal cell. The phase plate 3, 4 is a uniaxial ¼ wavelength plate having refractive index anisotropy as shown in FIG. 4. The slow axis of the phase plate 3, 4 has an angle of π/4 (rad), relative to the transmission axis of the polarizer plate 5, 6.

In the above structure, the paired phase plates 3 and 4 are configured to have slow axes that are intersect at right angles with each other, and thus function as negative phase plates. For example, a negative phase difference of about −280 mm is imparted to light with a wavelength of 550 nm. On the other hand, in order to obtain a phase difference of ½ wavelength by an electric field control, the liquid crystal layer 7 needs to have the value of Δn·d of 300 nm or more, which is obtained by multiplying the refractive index anisotropy An of the material by the thickness d of the liquid crystal layer. Consequently, the total phase difference of the liquid crystal display device does not become zero, and the viewing angle characteristics at the black display time deteriorate. In addition, since the uniaxial ¼ wavelength plate is used, a viewing angle dependency occurs in polarization characteristics of circularly polarized light that enters the liquid crystal layer, owing to the viewing angle characteristics of the polarizer plate.

As described above, in the prior-art circular-polarization-based MVA mode, substantially circularly polarized light is produced as the incident light that enters the liquid crystal layer. Thereby, the above-mentioned problem of low transmittance is overcome. However, there is such a problem that the contrast/viewing angle characteristic range is narrow because of lack of means for compensating the viewing angle dependency of circularly polarized light, which enters the liquid crystal layer, or the viewing angle dependency of the phase difference of the liquid crystal layer.

FIG. 10 shows an example of the measurement result of isocontrast curves of the liquid crystal display device having the structure shown in FIG. 9. The 0 deg. azimuth and 180 deg. azimuth correspond to the horizontal direction of the screen, and the 90 deg. azimuth and 270 deg. azimuth correspond to the vertical direction of the screen. As is shown in FIG. 10, the viewing angle with a contrast ratio of 10:1 is ±40° in the vertical direction and horizontal direction, and is narrow. Practically tolerable characteristics are not obtained.

An approach to address this problem has been proposed, wherein the uniaxial ¼ wavelength plate is replaced with a biaxial ¼ wavelength plate having refractive index anisotropy as shown in FIG. 12, thereby compensating the viewing angle dependency of circularly polarized light that enters the liquid crystal layer, and improving the viewing angle characteristics.

FIG. 11 shows an example of the cross-sectional structure of the circular-polarization-based MVA mode liquid crystal display device that uses biaxial ¼ wavelength plate 15 as shown in FIG. 12. In this structure, the ¼ wavelength plate has a refractive index ellipsoid of nx>ny>nz, as shown in FIG. 12. Thus, the in-plane phase difference is ¼ wavelength. If the upper and lower ¼ wavelength plates are disposed such that their in-plane slow axes intersect at right angles with each other, they function as negative phase plates. If their phase difference value is controlled, the phase difference in the normal direction of the liquid crystal layer can be compensated, and the viewing angle characteristics are improved.

FIG. 13 shows an actual measurement result of isocontrast curves of the circular-polarization-based MVA mode liquid crystal display device shown in FIG. 11. Compared to the result shown in FIG. 10, it is understood that the viewing angle is slightly increased and the characteristics are improved. However, the viewing angle with a contrast ratio of 10:1 or more is about ±80° and is wide in the oblique directions, but the viewing angle with a contrast ratio of 10:1 or more is about ±40° in the vertical and horizontal directions, which fails to satisfy practically tolerable viewing angle characteristics. The reason is as follows. The phase difference in the normal direction of the liquid crystal layer is improved to some degree by the above-described biaxial ¼ wavelength plates. An actually usable film, however, is a high-polymer film, and it is difficult to match it with wavelength dispersion of the phase difference of the liquid crystal layer. Furthermore, the film, as a circular polarizer plate, does not have such a structure as to have sufficient viewing angle characteristics, and this leads to the above-mentioned viewing angle characteristics of the contrast ratio.

To solve the problem, a circular-polarization-based MVA mode liquid crystal display device has been proposed, which uses a biaxial ¼ wavelength plate having a refractive index anisotropy as shown in FIG. 15, in place of the biaxial ¼ wavelength plate shown in FIG. 12.

FIG. 14 shows an example of the cross-sectional structure of a circular-polarization-based MVA mode liquid crystal display device that uses the biaxial ¼ wavelength plate 16 shown in FIG. 15. In this structure, the ¼ wavelength plate has a refractive index ellipticity of nx>ny<nz, as shown in FIG. 15. Like the structures shown in FIG. 9 and FIG. 11, the ¼ wavelength plates 16 and polarizer plates 5 and 6 are disposed on the outer surfaces of the MVA mode liquid crystal cell.

In the structure shown in FIG. 14, the ¼ wavelength plate that is used has a refractive index of ny<nz. Thus, even in the case where nx<nz and the ¼ wavelength plates are disposed above and below the liquid crystal cell so as to have slow axes perpendicular to each other, the effect of the negative phase difference is weakened, compared to the structure shown in FIG. 9 in which the upper and lower uniaxial ¼ wavelength plates are disposed to be perpendicular to each other. In the case where nx>nz, a positive phase difference occurs. Consequently, the contrast/viewing angle characteristic range becomes narrower than in the structure shown in FIG. 9, unless the refractive index anisotropy An of the liquid crystal layer is set to be very small, that is, unless the variation in phase difference of the liquid crystal layer is set below ½ wavelength and the transmittance of the liquid crystal cell becomes insufficient.

FIG. 16 shows an actual measurement result of isocontrast curves of the circular-polarization-based MVA mode liquid crystal display device shown in FIG. 14. As shown in FIG. 16, there occurs a region where the contrast ratio is 1:1 or less, and it is understood that the viewing angle characteristic range is narrower than in FIG. 10 or FIG. 13. This is partly because the structure of the polarizer plate, like the structure shown in FIG. 11, is not configured to obtain sufficient viewing angle characteristics as a circular polarizer plate.

Each of the structures shown in FIG. 11 and FIG. 14 uses the biaxial ¼ wavelength plate. The biaxial phase plate is formed by biaxial-drawing a high-polymer film, which leads to an increase in manufacturing cost. In addition, the refractive index is controllable only in a limited range, and it is difficult to realize a desired refractive index ellipsoid. Moreover, the range of selection of material for obtaining biaxiality is narrow, and it is difficult to match the material with the wavelength dispersion characteristic of the refractive index of the liquid crystal (see, for instance, T. Ishinabe et al., A Wide Viewing Angle Polarizer and a Quarter-wave Plate with a Wide Wavelength Range for Extremely High Quality LCDs, IDW '01 Proceedings, p. 485 (2001), and Y. Iwamoto et al., Improvement of Display Performance of High Transmittance Photo-Aligned Multi-domain Vertical Alignment LCDs Using Circular Polarizers, IDW '02 Proceedings, p. 85 (2002)).

### BRIEF SUMMARY OF THE INVENTION

The present invention has been made in consideration of the above-described problems, and the object of the invention is to provide a liquid crystal display device that can improve viewing angle characteristics and can reduce cost.

According to a first aspect of the invention, there is provided a circular-polarization-based vertical alignment mode liquid crystal display device wherein a dot-matrix liquid crystal cell, in which a liquid crystal layer is held between a pair of electrode-equipped substrates, is disposed between a first polarizer plate that is located on a light source side and a second polarizer plate that is located on an observation side, a first phase plate is disposed between the first polarizer plate and the liquid crystal cell, a second phase plate is disposed between the second polarizer plate and the liquid crystal cell, and liquid crystal molecules of each of pixels are oriented substantially vertical to a major surface of the substrate in a voltage-off state, the liquid crystal display device comprising:

a circular polarizer structure including the first polarizer plate and the first phase plate;

a variable retarder structure including the liquid crystal cell; and

a circular analyzer structure including the second polarizer plate and the second phase plate,

wherein the light source, the circular polarizer structure, the variable retarder structure and the circular analyzer structure are successively constructed in the named order,

each of the first phase plate and the second phase plate is a uniaxial ¼ wavelength plate that provides a phase difference of ¼ wavelength between light rays with a predetermined wavelength that pass through a fast axis and a slow axis thereof,

the circular polarizer structure includes first compensation means for compensating viewing angle characteristics of a circular polarizer such that emission light from the circular polarizer may become substantially circularly polarized light, regardless of the direction of emission, and

the variable retarder structure includes second compensation means for compensating viewing angle characteristics of a phase difference of the liquid crystal cell.

According to a second aspect of the invention, there is provided a circular-polarization-based vertical alignment mode liquid crystal display device wherein a dot-matrix liquid crystal cell, in which a liquid crystal layer is held between a pair of electrode-equipped substrates, is disposed between a first polarizer plate that is located on a light source side and a second polarizer plate that is located on an observation side, a first phase plate is disposed between the first polarizer plate and the liquid crystal cell, a second phase plate is disposed between the second polarizer plate and the liquid crystal cell, and liquid crystal molecules of each of pixels are oriented substantially vertical to a major surface of the substrate in a voltage-off state, the liquid crystal display device comprising:

a circular polarizer structure including the first polarizer plate and the first phase plate;

a variable retarder structure including the liquid crystal cell; and

a circular analyzer structure including the second polarizer plate and the second phase plate,

wherein the light source, the circular polarizer structure, the variable retarder structure and the circular analyzer structure are successively constructed in the named order,

each of the first phase plate and the second phase plate is a uniaxial ¼ wavelength plate that provides a phase difference of ¼ wavelength between light rays with a predetermined wavelength that pass through a fast axis and a slow axis thereof,

a third phase plate that has a refractive index anisotropy of nx>ny=nz is disposed between the first polarizer plate and the first phase plate such that a slow axis thereof is set to be substantially parallel to a transmission axis of the first polarizer plate, and

a fourth phase plate that has a refractive index anisotropy of nx=ny>nz is disposed between the liquid crystal cell and the first polarizer plate or the second phase plate.

In particular, the invention relates to a multi-domain vertical alignment mode (MVA mode) in which alignment of liquid crystal molecules are controlled such that the number of regions, where the orientation direction of liquid crystal molecules of the liquid crystal layer differs from an intended orientation direction, necessarily increases, that is, orientation directions of liquid crystal molecules in the pixel are non-uniform in a voltage-on state.

### BRIEF DESCRIPTION OF THE SEVERAL VIEWS OF THE DRAWING

FIG. 1 schematically shows an example of the cross-sectional structure of a liquid crystal display device according to an embodiment of the present invention;

FIG. 2 is a view for explaining a refractive index ellipsoid of a fourth phase plate that is applicable to the liquid crystal display device shown in FIG. 1;

FIG. 3 is a view for explaining a refractive index ellipsoid of a third phase plate that is applicable to the liquid crystal display device shown in FIG. 1;

FIG. 4 is a view for explaining a refractive index ellipsoid of a first phase plate and a second phase plate that are applicable to the liquid crystal display device shown in FIG. 1;

FIG. 5 is a view for explaining a compensation principle of contrast/viewing angle characteristics of the liquid crystal display device shown in FIG. 1;

FIG. 6 shows an example of isocontrast curves of a liquid crystal display device according to Embodiment 1;

FIG. 7A shows an example of isocontrast curves of a liquid crystal display device according to Embodiment 2, wherein a rubbing process is executed in a direction parallel to the absorption axis of the polarizer plate;

FIG. 7B shows an example of isocontrast curves of a liquid crystal display device according to Embodiment 2, wherein a rubbing process is executed in a direction at 45° relative to the absorption axis of the polarizer plate;

FIG. 8A shows x-y chromaticity coordinates for explaining an example of viewing angle characteristics of chromaticity at a black display time of a liquid crystal display device according to Embodiment 3, wherein a liquid crystal polymer is applied to a fourth phase plate;

FIG. 8B shows x-y chromaticity coordinates for explaining an example of viewing angle characteristics of chromaticity at a black display time of a liquid crystal display device according to Embodiment 3, wherein ARTON resin is applied to a fourth phase plate;

FIG. 9 is a view for explaining an example of the cross-sectional structure of a prior-art liquid crystal display device;

FIG. 10 shows an example of isocontrast curves of the liquid crystal display device shown in FIG. 9;

FIG. 11 is a view for explaining an example of the cross-sectional structure of a prior-art liquid crystal display device;

FIG. 12 is a view for explaining a refractive index ellipsoid of a biaxial ¼ wavelength plate that is used in the liquid crystal display device shown in FIG. 11;

FIG. 13 shows an example of isocontrast curves of the liquid crystal display device shown in FIG. 11;

FIG. 14 is a view for explaining an example of the cross-sectional structure of a prior-art liquid crystal display device;

FIG. 15 is a view for explaining a refractive index ellipsoid of a biaxial ¼ wavelength plate that is used in the liquid crystal display device shown in FIG. 14; and

FIG. 16 shows an example of isocontrast curves of the liquid crystal display device shown in FIG. 14.

### DETAILED DESCRIPTION OF THE INVENTION

A liquid crystal display device according to an embodiment of the present invention will now be described with reference to the accompanying drawings. The liquid crystal display device to be described here includes a liquid crystal cell of an MVA mode, which is one of birefringence modes wherein a refractive index in a normal direction of the substrate in the liquid crystal layer may be greater than a refractive index in a predetermined direction in the plane of the substrate. This invention, however, is applicable to a structure including a liquid crystal cell of some other birefringence mode.

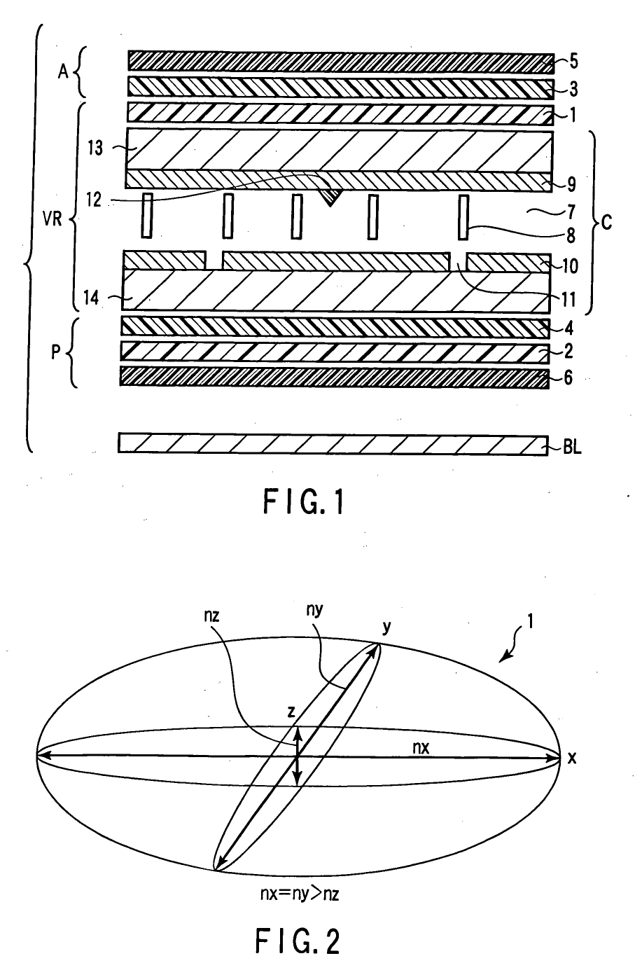

FIG. 1 schematically shows the structure of a liquid crystal display device according an embodiment of the invention. As is shown in FIG. 1, the liquid crystal display device has a circular-polarization-based vertical alignment mode in which liquid crystal molecules in each pixel are aligned substantially vertical to the major surface of the substrate in a voltage-off state. The liquid crystal display device comprises a circular polarizer structure P, a variable retarder structure VR and a circular analyzer structure A.

The variable retarder structure VR includes a dot-matrix liquid crystal cell C in which a liquid crystal layer is held between a pair of substrates, that is, two electrode-equipped substrates. This liquid crystal cell C is an MVA mode liquid crystal cell, and a liquid crystal layer 7 is sandwiched between an active matrix substrate 14 and an opposed substrate 13. The distance between the active matrix substrate 14 and opposed substrate 13 is kept constant by a spacer (not shown).

The active matrix substrate 14 is configured to include an insulating substrate with light transmissivity, such as a glass substrate. One major surface of the active matrix substrate 14 is provided with, e.g. various lines such as scan lines and signal lines, and switching elements provided near intersections of the scan lines and signal lines. A description of these elements is omitted since they are not related to the operation of the present invention. Pixel electrodes 10 are provided on the active matrix substrate 14. The surfaces of the pixel electrodes 10 are covered with an orientation film.

The various lines, such as scan lines and signal lines, are formed of aluminum, molybdenum, copper, etc. The switching element is a thin-film transistor (TFT) including a semiconductor layer of, e.g. amorphous silicon or polysilicon, and a metal layer of, e.g. aluminum, molybdenum, chromium, copper or tantalum. The switching element is connected to the scan line, signal line and pixel electrode 10. On the active matrix substrate 14 with this structure, a voltage can selectively be applied to a desired one of the pixel electrodes 10.

The pixel electrode 10 may be formed of an electrically conductive material with light transmissivity, such as ITO (Indium Tin Oxide). The pixel electrode 10 is formed by providing a thin film using, e.g. sputtering, and then patterning the thin film using an etching technique.

The orientation film is formed of a thin film of a resin material with light transmissivity, such as polyimide. In this embodiment, the orientation film is not subjected to a rubbing process, and liquid crystal molecules are vertically aligned.

The opposed substrate 13 is configured to include an insulating substrate with light transmissivity, such as a glass substrate. A common electrode 9 is provided on one major surface of the opposed substrate 13. The surface of the common electrode 9 is covered with an orientation film.

The common electrode 9, like the pixel electrode 10, may be formed of an electrically conductive material with light transmissivity, such as ITO. The orientation film, like the orientation film on the active matrix substrate 14, may be formed of a resin material with light transmissivity, such as polyimide. In this embodiment, the common electrode 9 is formed as a planar continuous film that faces all the pixel electrodes with no discontinuity.

When the present display device is constructed as a color liquid crystal device, the liquid crystal cell C includes color filter layers. The color filter layers are color layers of, e.g. the three primary colors of blue, green and red. The color filter may be provided between the insulating substrate of the active matrix substrate 14 and the pixel electrode 10 with a COA (Color Filter on Array) structure, or may be provided on the opposed substrate 13.

If the COA structure is adopted, the color filter layer is provided with a contact hole, and the pixel electrode 10 is connected to the switching element via the contact hole. The COA structure is advantageous in that high-precision alignment using, e.g. alignment marks is needless when the liquid crystal cell C is to be formed by attaching the active matrix substrate 14 and opposed substrate 13.

The liquid crystal layer 7 is formed of a nematic liquid crystal material with negative dielectric anisotropy. Specifically, F-series liquid crystal (manufactured by Merck) is used. The refractive index anisotropy Δn of the liquid crystal material is 0.102 (the wavelength for measurement is 550 nm; hereinafter, all values of the refractive index and phase difference of the phase plate are measured at the wavelength of 550 nm). The thickness d of the liquid crystal layer 7 is 3.7 μm. Accordingly, the value Δn·d is 377 nm.

The circular polarizer structure P is disposed between the light source, i.e. a backlight unit BL, and the variable retarder structure VR. The circular polarizer structure P includes a first polarizer plate 6 that is located on the backlight unit BL side of the liquid crystal cell C, and a first phase plate 4 that is disposed between the first polarizer plate 6 and liquid crystal cell C.

The circular analyzer structure A is disposed on the observation surface side of the variable retarder structure VR, which is opposed to the backlight unit BL. The circular analyzer structure A includes a second polarizer plate 5 that is disposed on the observation surface side of the liquid crystal cell C, and a second phase plate 3 that is disposed between the second polarizer plate 5 and liquid crystal cell C.

Each of the first polarizer plate 6 and second polarizer plate 5 has a transmission axis and an absorption axis, which are substantially perpendicular to each other in the plane thereof. Each of the first phase plate 4 and second phase plate 3 has a fast axis and a slow axis, which are substantially perpendicular to each other in the plane thereof. Each of the first phase plate 4 and second phase plate 3 is a uniaxial ¼ wavelength plate that provides a phase difference of ¼ wavelength between light rays with a predetermined wavelength (e.g. 550 nm), which pass through the fast axis and slow axis. The first phase plate 4 and second phase plate 3 are disposed such that their slow axes intersect at right angles with each other.

The liquid crystal display device is constructed by successively stacking the backlight unit BL, circular polarizer structure P, variable retarder structure VR and circular analyzer structure A. In the liquid crystal display device with this structure, the circular polarizer structure P includes first compensation means 2 that compensates the viewing angle characteristics (visual characteristics due to the first polarizer plate) of the polarizer so that emission light from the circular polarizer structure may become substantially circularly polarized light, regardless of the direction of emission. In addition, the variable retarder structure VR includes second compensation means 1 for compensating the viewing angle characteristics of the phase difference of the liquid crystal cell C.

Specifically, the circular polarizer structure P includes an optically uniaxial third phase plate (A plate) 2 that is disposed between the first polarizer plate 6 and first phase plate 4 and has a refractive index anisotropy of nx>ny=nz. The third phase plate 2 is disposed such that the slow axis thereof is set to be substantially parallel to the transmission axis of the first polarizer plate 6.

On the other hand, the variable retarder structure VR includes an optically negative uniaxial fourth phase plate (C plate) 1 that is disposed between the liquid crystal cell C and the first phase plate 4 or second phase plate 3 and has a refractive index anisotropy of nx=ny>nz. In the embodiment shown in FIG. 1, the fourth phase plate 1 is disposed between the liquid crystal cell C and second phase plate 3.

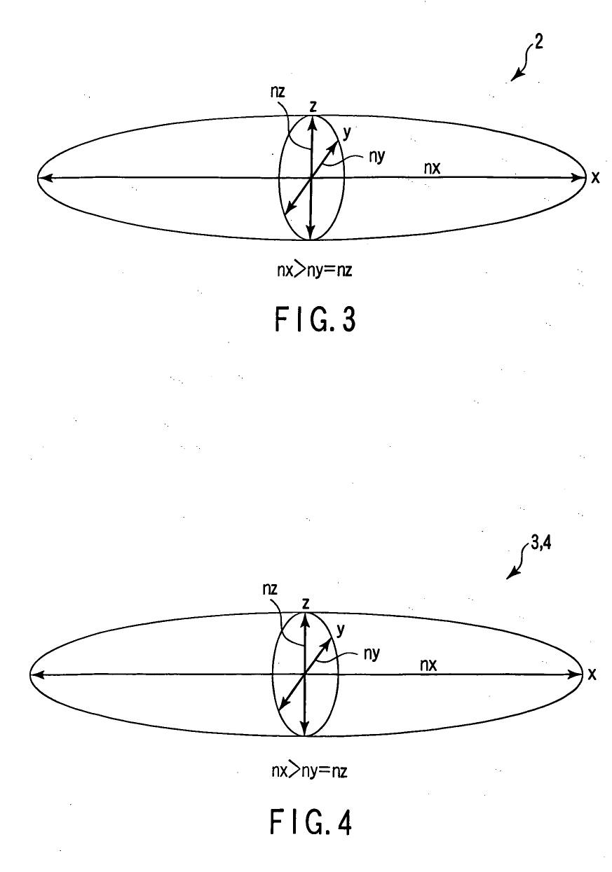

A phase plate that is applicable to the fourth phase plate 1 should have a refractive index ellipsoid (nx=ny<nz) as shown in FIG. 2. A phase plate that is applicable to the third phase plate 2 should have a refractive index ellipsoid (nx>ny=nz) as shown in FIG. 3. A phase plate, which is a kind of A plate that has a refractive index ellipsoid (nx>ny=nz) as shown in FIG. 4, is applicable to the first phase plate 4 and second phase plate 3. In FIG. 2 to FIG. 4, nx and ny designate refractive indices in the plane of the phase plate, and nz indicates the refractive index in the normal direction to the surface thereof.

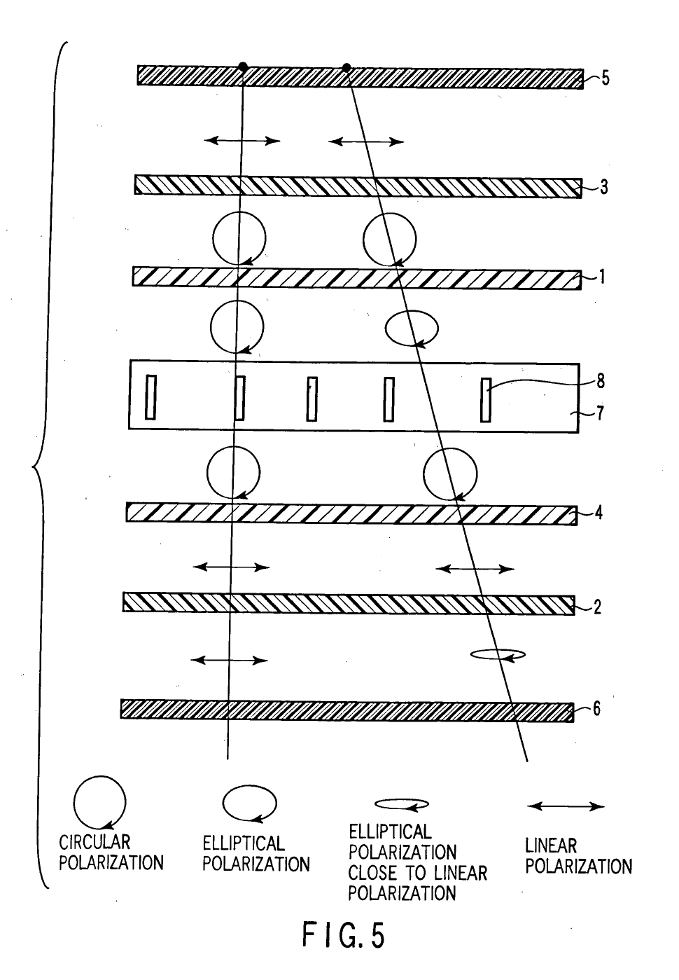

FIG. 5 is a conceptual view of the polarization state in respective optical paths, illustrating the optical principle of the viewing angle characteristics of the liquid crystal display device shown in FIG. 1.

The liquid crystal display device uses the optically negative uniaxial medium, i.e. the fourth phase plate (C plate) 1, which is made to function as a negative phase plate along with the first phase plate 4 and second phase plate 3. Thereby, the viewing angle dependency of the phase difference in the normal direction of the liquid crystal layer 7, whose Δn·d is 280 nm or more, is compensated. The fourth phase plate 1 with this compensation function is provided between the first phase plate 4 and second phase plate 3, that is, between the liquid crystal layer 7, and first phase plate 4 or second phase plate 3. Thus, if light that is incident on the first phase plate 4 and second phase plate 3 is linearly polarized light, the light that is emitted from the first phase plate 4 and second phase plate 3 becomes substantially circularly polarized light, regardless of the emission angle or emission direction.

Accordingly, in the case where the fourth phase plate 1 is situated between the liquid crystal layer 7 and second phase plate 3, the light that is incident on the liquid crystal layer 7 becomes circularly polarized light, irrespective of the incidence angle or incidence direction. Even if the circularly polarized light becomes elliptically polarized light due to the phase difference in the normal direction of the liquid crystal layer 7, the elliptically polarized light is restored to the circularly polarized light by the function of the fourth phase plate 1. Thus, the light that is incident on the second phase plate 3 disposed on the fourth phase plate 1 becomes circularly polarized light, irrespective of the incidence angle or incidence direction. Therefore, good display characteristics can be obtained irrespective of the viewing direction.

In the case where the fourth phase plate 1 is situated between the liquid crystal layer 7 and first phase plate 4, the light that is incident on the fourth phase plate 1 becomes circularly polarized light, irrespective of the incidence angle or incidence direction. Even if the circularly polarized light becomes elliptically polarized light due to the phase difference in the normal direction of the fourth phase plate 1, the elliptically polarized light is restored to the circularly polarized light by the function of the liquid crystal layer 7. Thus, the light that is incident on the second phase plate 3 disposed on the liquid crystal layer 7 becomes circularly polarized light, irrespective of the incidence angle or incidence direction. Therefore, good display characteristics can be obtained irrespective of the viewing direction, like the case where the fourth phase plate 1 is disposed between the liquid crystal layer 7 and second phase plate 3.

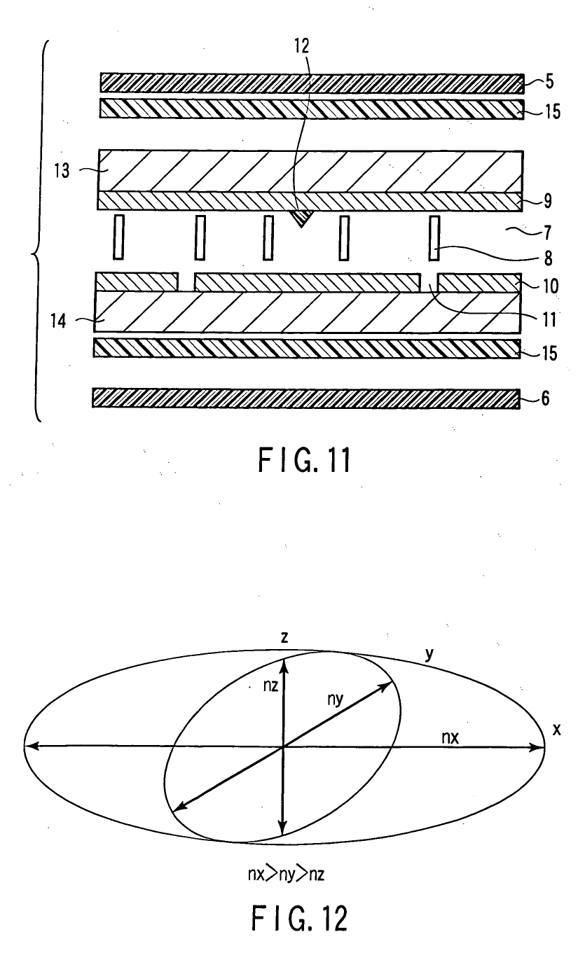

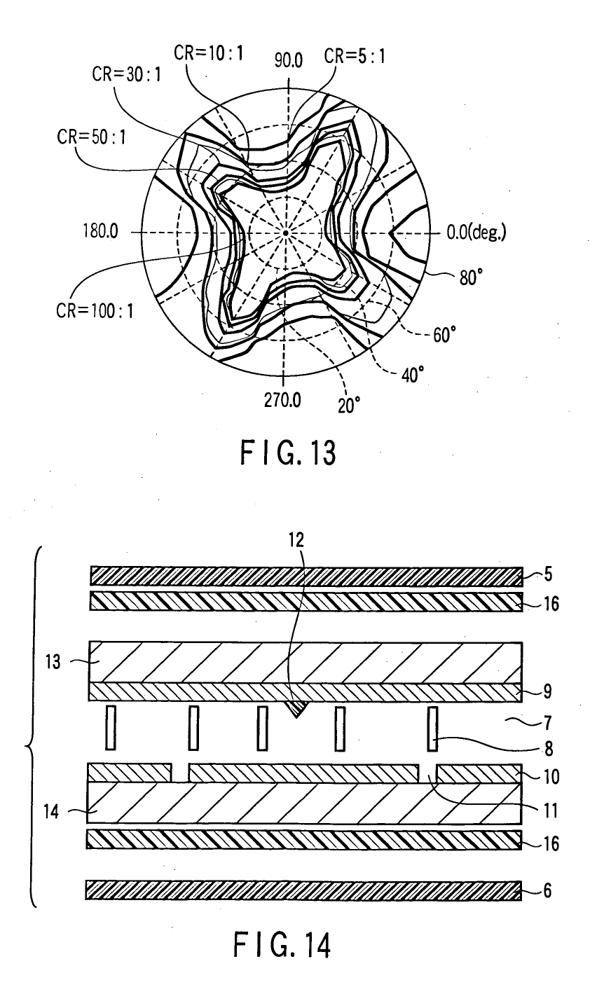

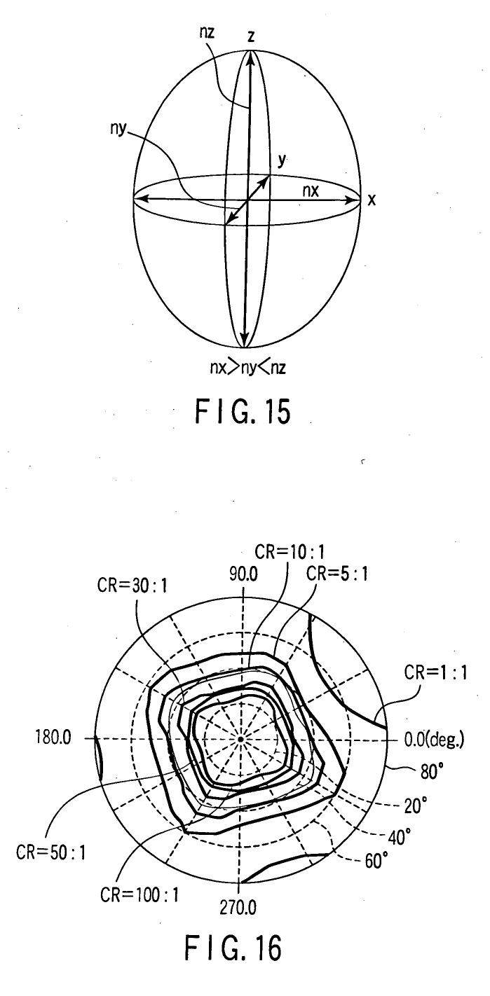

On the other hand, in the circular-polarization-based MVA mode liquid crystal display device that has the structure shown in FIG. 11, the biaxial ¼ wavelength plates 15, which have a refractive index ellipsoid of nx>ny>nz, are disposed. The slow axes of the paired ¼ wavelength plates 15 are made to intersect at right angles with each other. These ¼ wavelength plates 15 have a function of simultaneously realizing the fourth phase plate 1, first phase plate 4 and second phase plate 3. If the condition for compensating the phase difference in the normal direction of the liquid crystal layer 7 is also set, the light that is emitted from the biaxial ¼ wavelength plate necessarily becomes elliptically polarized light. Thus, the light that is emitted from the biaxial ¼ wavelength plate becomes polarized light that is polarized in the major-axis direction of the ellipsoid. As a result, transmittance characteristics, which depend on the liquid crystal molecule orientation direction, are obtained, and a sufficient viewing angle compensation effect cannot be obtained depending on directions, as shown in FIG. 13.

By contrast, in the liquid crystal display device structure of this embodiment, the polarized light, which is incident in the liquid crystal layer 7 and the fourth phase plate 1 that compensates the phase difference in the normal direction of the liquid crystal layer 7, is the circularly polarized light with no directional polarity. Therefore, the above-mentioned problem does not occur, and the compensation effect that does not depend on directions can be obtained.

In order to sufficiently obtain this effect, first compensation means for compensating the viewing angle characteristics of the first polarizer plate 6, that is, the uniaxial third phase plate (i.e. A plate) 2 that has the refractive index ellipsoid of nx>ny=nz, as shown in FIG. 3, should be disposed between the first wavelength plate 4 and first polarizer plate 6 on the light incidence side such that the slow axis thereof is substantially parallel to the transmission axis of the first polarizer plate 6. Thereby, better viewing angle characteristics can be obtained.

The structure without the third phase plate 2, as the optical structure of the entire device, is equivalent to the structure shown in FIG. 11 in terms of the total phase difference. However, the order of arrangement of the optical components and the number of optical components used are different. As described above, however, the optical compensation that does not depend on the liquid crystal molecule orientation direction is first achieved by changing the light, which is incident on the liquid crystal layer 7 and the fourth phase plate 1 that compensates the phase difference in the normal direction of the liquid crystal layer 7, to polarity-free circularly polarized light. In short, even if the fourth phase plate 1, third phase plate 2, first phase plate 4 and second phase plate 3, which are described in the embodiment, are adopted, the same advantageous effect cannot be obtained unless the structure shown in FIG. 1 is used.

For example, in the case where the fourth phase plate 1 is disposed between the first phase plate 4 and first polarizer plate 6, the polarized light that is incident on the first phase plate 4 becomes elliptically polarized light depending on the incidence direction. Consequently, even if the light passes through the first phase plate 4 does not become circularly polarized light, and the above-described effect cannot be obtained. In addition, even if the third phase plate 2 is disposed between the second polarizer plate 5 and second phase plate 3, the viewing angle characteristics of the first polarizer plate 6 are not compensated. Thus, the light that emerges from the first phase plate 4 becomes elliptically polarized light and the above-described effect cannot be obtained.

Preferably, the liquid crystal display device of the above-described embodiment should have a multi-domain vertical alignment mode in which liquid crystal molecules in the pixel are controlled and oriented in at least two directions in a voltage-on state. In addition, in at least half the opening region of each pixel, the orientation direction of liquid crystal molecules in the pixel in a voltage-on state should be controlled to become substantially parallel to the absorption axis or transmission axis of the second polarizer plate 5.

This orientation control can be realized by providing a protrusion 12 for multi-domain control in the pixel, as shown in FIG. 1. The orientation control can also be realized by forming a slit 11 for multi-domain control at a part of the pixel electrode 10. Further, the orientation control can be realized by providing orientation films, which are subjected to an orientation process of, e.g. rubbing, for multi-domain control, on those surfaces of the active matrix substrate 14 and opposed substrate 13, which sandwich the liquid crystal layer 7. Needless to say, at least two of the protrusion 12, slit 11 and orientation film that is subjected to the orientation process may be combined.

As mentioned above, in the linear-polarization-based MVA mode liquid crystal display device, the maximum transmittance is obtained when the orientation direction of liquid crystal molecules is at an angle of π/4(rad) to the transmission axis of the polarizer plate (i.e. when the value of θ in equation (1) of Tlp(LC) is π/4(rad)). Thus, in the case of the circular-polarization-based MVA mode, the multi-domain structure (protrusion or slit) is provided in the pixel or the orientation film is subjected to an orientation process such as rubbing, so that the liquid crystal molecule orientation direction in the pixel in the voltage-on state may be inclined at an angle of π/4(rad) to the transmission axis of the polarizer plate.

On the other hand, in the case of the circular-polarization-based MVA mode liquid crystal display device, the transmittance does not depend on the liquid crystal molecule orientation direction in the pixel in the voltage-on state. Thus, if a phase difference of ½ wavelength is obtained by the liquid crystal layer 7 and fourth phase plate 1, excellent transmittance characteristics can be obtained regardless of the liquid crystal molecule orientation direction.

In the multi-domain vertical alignment mode, the multi-domain structure is constituted so as to obtain the phase difference of ½ wavelength regardless of the light incidence angle. However, depending on the incidence angle or the tilt angle of liquid crystal molecules, there may be a case where the orientation dependence of phase difference cannot be compensated by the multi-domain structure. In order to minimize this problem, the liquid crystal molecule orientation direction should be made parallel to the transmission axis or absorption axis of the polarizer plate. The reason is that when the light that emerges from the liquid crystal layer 7 and fourth phase plate 1 becomes elliptically polarized light, and not circularly polarized light, the major-axis direction of the elliptically polarized light becomes parallel to the optical axis (transmission axis and absorption axis) of the second polarizer plate 5 that is the analyzer.

In the liquid crystal display device according to the above-described embodiment, the fourth phase plate 1 may be formed of a film including a C plate layer that is formed of one of chiral nematic, cholesteric, and discotic liquid crystal polymer.

As has been described above, in the present embodiment, the fourth phase plate 1 is used in order to compensate the phase difference in the normal direction of the liquid crystal layer 7. The phase difference of the liquid crystal layer 7 to be compensated includes wavelength dispersion. In order to compensate the phase difference of the liquid crystal layer 7 including the wavelength dispersion, a more excellent compensation effect can be obtained if the fourth phase plate 1 that is the compensation plate has the same wavelength dispersion. Therefore, it is better to form the fourth phase plate 1 of a liquid crystal polymer, as mentioned above.

If the C plate layer of the fourth phase plate 1 is formed on the second phase plate 3 (i.e. the surface opposed to the liquid crystal cell C), the base film for forming the fourth phase plate 1 and the second phase plate 3 can be integrated, so the number of components and the entire film thickness can be reduced and the reduction in thickness can advantageously be realized.

Preferably, in the liquid crystal display device according to the present embodiment, the third phase plate 2 should be formed of a resin that has a retardation value, which hardly depends on an incidence light wavelength in a plane thereof, such as ARTON resin, polyvinyl alcohol resin, ZEONOR resin, or triacetyl cellulose resin.

As described above, the third phase plate 2, which is disposed between the first phase plate 4 and first polarizer plate 6, has the function of compensating the viewing angle characteristics of the polarizer plate. The viewing angle characteristics of the polarizer plate hardly depend on the wavelength. Unlike the fourth phase plate 1, it is desirable that the wavelength dispersion of the phase difference of the third phase plate 2 that is the compensation plate be small. Therefore, the third phase plate 2 is more effective if it is formed of the above-mentioned material with less wavelength dispersion of phase difference.

In the liquid crystal display device of this embodiment, the respective wavelength dispersions can individually be controlled by separating the viewing angle compensation function for the liquid crystal layer 7 and the viewing angle compensation function for the polarizer plate. Compared to the prior art in which these functions are performed at the same time, the compensation effect for wavelength becomes excellent.

Preferably, in the liquid crystal display device according to the present embodiment, the fourth phase plate should satisfy the following formula,
Δn(LC)×d(LC)≧{nxy(C)−nz(C)}×d(C)≧Δn(LC)×d(LC)−λ/2
where nxy(C) is an in-plane refractive index, nz(C) is a normal-directional refractive index, d(C) is a thickness, Δn(LC) is a refractive index anisotropy of liquid crystal material of the liquid crystal layer 7 in the liquid crystal cell C, d(LC) is a thickness of the liquid crystal layer 7 in the liquid crystal cell C, and λ is the wavelength of incident light to the liquid crystal display device.

The phase difference in the normal direction of the liquid crystal layer 7 due to the fourth phase plate 1 is expressed by Δn(LC)×d(LC). The phase difference in the normal direction of each of the first phase plate 4 and second phase plate 3 (both being ¼ wavelength plates) is expressed by −λ/2. In the case where the phase difference in the normal direction of the ¼ wavelength plate is eliminated by using a biaxial ¼ wavelength plate, the phase difference, {nxy(C)−nz(C)}×d(C), of the fourth phase plate 1 that eliminates the phase difference in the normal direction of the liquid crystal layer 7 becomes Δn(LC)×d(LC).

On the other hand, if the phase difference in the normal direction of the ¼ wavelength plate is not eliminated, the phase difference becomes Δn(LC)×d(LC)−λ/2. If the phase difference is not eliminated, the circularly polarized light that enters the liquid crystal layer 7 and fourth phase plate 1 is made slightly elliptical, but this phenomenon is substantially negligible since the slow axis is present in the in-plane direction.

Assuming that the degree of polarization of the polarizer plate is ∞, it is preferable that the phase difference, {nxy(C)−nz(C)}×d(C), of the fourth phase plate be Δn(LC)×d(LC)−λ/2. However, it is, in fact, impossible to set the degree of polarization of the polarizer plate at ∞, regardless of wavelength. If the degree of polarization is increased regardless of wavelength, the transmittance would decrease. It is thus necessary to set a degree of polarization that can provide a practical transmittance. In this case, since the degree of polarization is not enough, the absolute value of the phase difference of the fourth phase plate 1 needs to be increased.

The phase difference value in this case does not exceed the ½ wavelength at which the polarization state takes an inverse shape-. In order to obtain the above-described compensation effect, it is necessary to set the absolute value of the optimal phase difference of the fourth phase plate 1 at Δn(LC)×d(LC), which is greater than Δn(LC)×d(LC)−λ/2 that is the optimal value when the degree of polarization of the polarizer plate is assumed to be ∞, and which is not greater than the ½ wavelength at which the polarization state takes an inverse shape.

Specific embodiments of the present invention will now be described.

### EMBODIMENT 1

In Embodiment 1, uniaxial ¼ wavelength plates (in-plane phase difference is 140 nm), which were formed of ARTON resin (manufactured by NITTO DENKO CORPORATION), were applied to the first phase plate 4 and second phase plate 3. The surface of the film used as the second phase plate 3 (i.e. the surface opposed to the liquid crystal cell C) was rubbed. On the rubbed surface, ultraviolet-curing chiral nematic liquid crystal (manufactured by Merck & Co., Inc.), which has refractive index anisotropy Δn of 0.102 and has a helical pitch of 0.9 μm, was coated to a thickness of 2.2 μm. In the state in which the helical axis is set in the normal direction of the film, ultraviolet irradiation was performed. Thus, the liquid-crystal-polymerized fourth phase plate (C plate layer) 1 was formed integral with the second phase plate 3.

The absolute value of the phase difference in the normal direction of the obtained fourth phase plate 1 is 205 nm. The second phase plate 3 having the fourth phase plate 1 was attached, as shown in FIG. 1, using an adhesive, such that the fourth phase plate 1 was located on the liquid crystal layer 7 side. A polarizer plate SEG1224DU (manufactured by NITTO DENKO CORPORATION) that serves as the second polarizer plate 5 was attached to the second phase plate 3 via an adhesive layer.

On the other hand, a uniaxial phase plate, which is formed of ARTON resin (manufactured by NITTO DENKO CORPORATION) and has an in-plane phase difference of 400 nm, was applied to the third phase plate 2. The same ¼ wavelength plate as the second phase plate 3 was applied to the first phase plate 4. Further, a polarizer plate SEG1224DU (manufactured by NITTO DENKO CORPORATION) was applied to the first polarizer plate 6. The first phase plate 4, third phase plate 2 and first polarizer plate 6 were successively attached via adhesive layers in the named order from the substrate 14 side.

The angle formed between the transmission axis of each of the first polarizer plate 6 and second polarizer plate 5 and the slow axis of each of the first phase plate 4 and second phase plate 3 is π/4(rad). The transmission axis of the first polarizer plate 6 is parallel to the slow axis of the third phase plate 2. The protrusion 12 or slit 11 is disposed such that the liquid crystal molecule orientation direction in the voltage-on state of the liquid crystal layer 7 is parallel or perpendicular to the transmission axis of the polarizer plate 5, 6. The absorption axis of the second polarizer plate 5 and the absorption axis of the first polarizer plate 6 are set to be perpendicular to each other.

In the liquid crystal display device with this structure, a voltage of 4.2 V (at white display time) and a voltage of 1.0 V (at black display time; this voltage is lower than a threshold voltage of liquid crystal material, and with this voltage the liquid crystal molecules remain in the vertical alignment) were applied to the liquid crystal layer 7, and the viewing angle characteristics of the contrast ratio were evaluated.

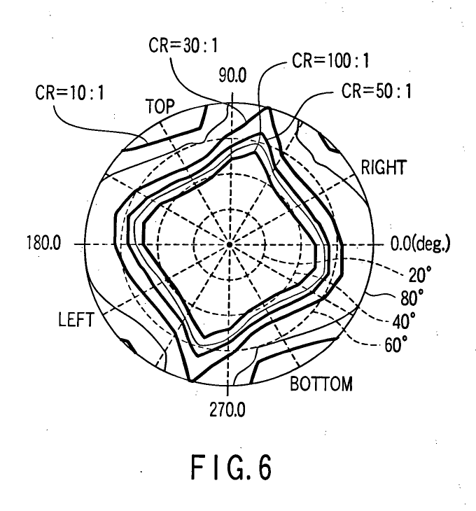

FIG. 6 shows the evaluation result. The 30 (deg.) azimuth and 210 (deg.) azimuth correspond to the horizontal direction of the screen, and the 120 (deg.) azimuth and 300 (deg.) azimuth correspond to the vertical direction of the screen. It was confirmed that in almost all azimuth directions, the viewing angle with a contrast ratio of 10:1 was ±80° or more, and excellent viewing angle characteristics were obtained. In addition, the transmittance at 4.2 V was measured, and it was confirmed that a very high transmittance of 5.0% was obtained.

### EMBODIMENT 2

In the liquid crystal display device with the structure shown in FIG. 1, the formation of the slit 11 in the pixel electrode was omitted. In addition, the formation of the protrusion 12 in the opposed substrate was omitted. Instead, the surfaces of the orientation films provided on the respective substrates were rubbed in a uniform direction. In the other respects, the same materials, structures and fabrication method as with Embodiment 1 were adopted. Thus, a non-multi-domain vertical alignment mode liquid crystal display device was formed.

Two kinds of liquid crystal display devices were formed. In one device, the rubbing direction was set to be parallel to the absorption axis of the second polarizer plate 5. In the other device, the rubbing direction was set at 45° to the absorption axis of the second polarizer plate 5. A voltage of 4.2 V and a voltage of 1.0 V were applied to the liquid crystal layers 7 of the two kinds of liquid crystal display devices. The viewing angle characteristics of the contrast ratio were evaluated.

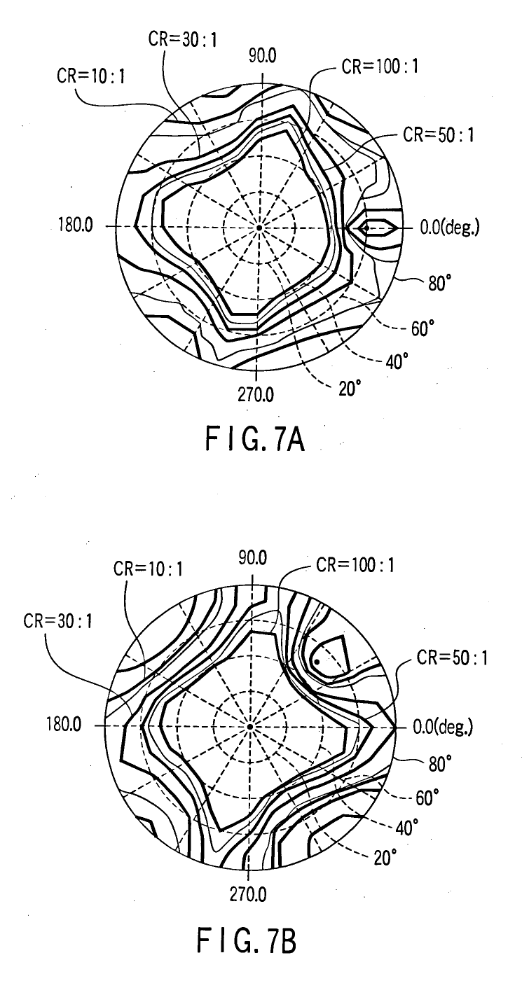

The respective evaluation results are shown in FIG. 7A and FIG. 7B. FIG. 7A shows the evaluation result of the device in which the rubbing direction was set to be parallel to the absorption axis of the second polarizer plate 5. FIG. 7B shows the evaluation result of the device in which the rubbing direction was set at 45° to the absorption axis of the second polarizer plate 5. Each evaluation result demonstrates that wide contrast/viewing angle characteristics were obtained. As is clear from FIG. 7A and FIG. 7B, it was confirmed that a wider contrast viewing angle was obtained with the structure of FIG. 7A wherein the rubbing process was executed to make the liquid crystal molecule orientation direction parallel to the absorption axis or the transmission axis of the polarizer plate.

### COMPARATIVE EXAMPLE 1

In the structure shown in FIG. 1, the first phase plate 4, second phase plate 3, third phase plate 2 and fourth phase plate 1 were omitted. Thus, the liquid crystal molecule orientation direction was set at 45° to the absorption axis of the polarizer plate. As regards the other conditions, the same materials and fabrication method as with Embodiment 1 were adopted. Thereby, a linear-polarization-based MVA mode liquid crystal display device was formed. Like Embodiment 1, the transmittance was measured. The measured transmittance was 4.0%, which was lower than in Embodiment 1 or Embodiment 2.

### COMPARATIVE EXAMPLE 2

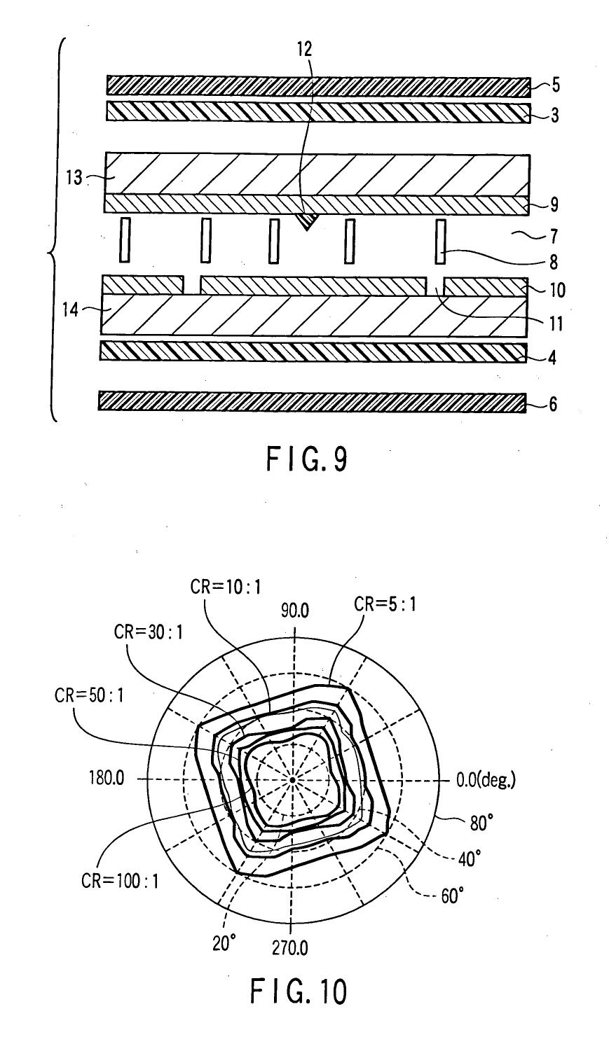

A liquid crystal display device with the structure shown in FIG. 9 was fabricated. Except that the third phase plate 2 and fourth phase plate 1 in Embodiment 1 were omitted, the same materials and fabrication method as with Embodiment 1 were adopted. Thus, a liquid crystal display device was formed. Like Embodiment 1, the viewing angle dependency of the contrast ratio was measured. FIG. 10 shows the measurement result. As is shown in FIG. 10, it was confirmed that the viewing angle with a contrast ratio of 10:1 was ±40° in the vertical and horizontal directions, and was narrower than in Embodiment 1 or Embodiment 2.

### COMPARATIVE EXAMPLE 3

A liquid crystal display device having a structure shown in FIG. 11 was fabricated. Biaxial phase plates, which are formed of ARTON resin (manufactured by NITTO DENKO CORPORATION), were used. The in-plane phase difference was 140 nm, and the phase difference in the normal direction (the value calculated by multiplying nx-nz by the layer thickness) was 105 nm. Like Embodiment 1, the viewing angle dependency of the contrast ratio was measured. FIG. 13 shows the measurement result. As shown in FIG. 13, the viewing angle with a contrast ratio of 10:1 or more is ±80° in the oblique direction and is wide. However, the viewing angle with a contrast ratio of 10:1 or more is ±40° in the vertical and horizontal directions and is narrower than in Embodiment 1 or Embodiment 2.

### EMBODIMENT 3

Two kinds of liquid crystal display devices were fabricated. In one device, a fourth phase plate 1 that is formed of the same material as the fourth phase plate 1 of Embodiment 1 was used. In the other device, a fourth phase plate that is formed of ARTON resin was used. In the other respects, the structures, materials, fabrication method and optical physical property values were the same as those in Embodiment 1. A voltage of 1.0 V was applied to the liquid crystal layer, and the viewing angle dependency of chromaticity at a black display time was evaluated.

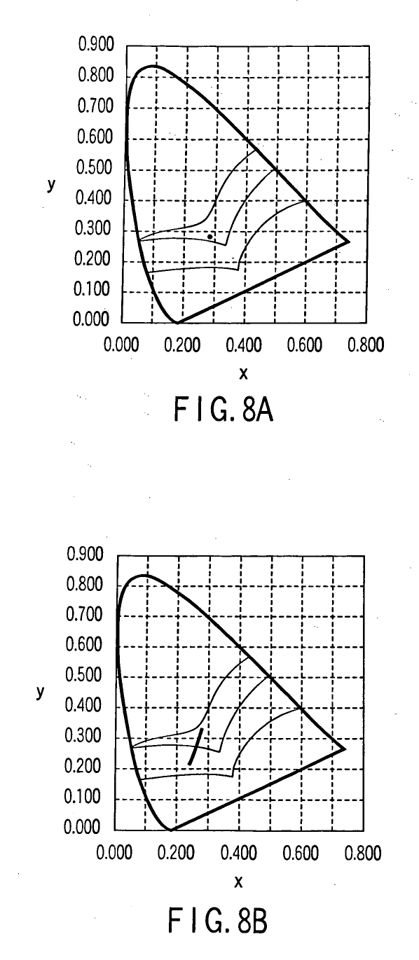

The respective evaluation results are shown in FIG. 8A and FIG. 8B. FIG. 8A shows the evaluation result of the liquid crystal display device wherein the fourth phase plate 1 formed of a liquid crystal polymer is used. FIG. 8B shows the evaluation result of the liquid crystal display device wherein the fourth phase plate 1 formed of ARTON resin is used. Each evaluation result is obtained by plotting all chromaticity evaluation results in a 80° cone viewing field. Either result demonstrates good chromaticity/viewing angle characteristics. It was confirmed that more excellent chromaticity/viewing angle characteristics were obtained in FIG. 8A relating to the structure of Embodiment 1.

As has been described above, the present invention provides a novel structure of a liquid crystal display device. This structure aims at preventing a decrease in transmittance, which occurs when liquid crystals are schlieren-oriented or orientated in an unintentional direction in a display mode, such as a vertical alignment mode or a multi-domain vertical alignment mode, in which the phase of incident light is modulated by about ½ wavelength in the liquid crystal layer. This invention can solve such problems that the viewing angle characteristic range is narrow and the manufacturing cost of components that are used is high, in the circular-polarization-based display mode in which circularly polarized light is incident on the liquid crystal layer, in particular, in the circular-polarization-based MVA display mode.

According to the novel structure, like the conventional circular-polarization-based MVA mode, high transmittance characteristics can be obtained and excellent contrast/viewing angle characteristics are realized. Moreover, the manufacturing cost is lower than in the circular-polarization-based MVA mode using the conventional viewing angle compensation structure.

The present invention is not limited to the above-described embodiments. At the stage of practicing the invention, various modifications and alterations may be made without departing from the spirit of the invention. Structural elements disclosed in the embodiments may properly be combined, and various inventions can be made. For example, some structural elements may be omitted from the embodiments. Moreover, structural elements in different embodiments may properly be combined.

As has been described above, the present invention can provide a liquid crystal display device that can improve viewing angle characteristics and can reduce cost.

What is claimed is:

1. A circular-polarization-based vertical alignment mode liquid crystal display device wherein a dot-matrix liquid crystal cell, in which a liquid crystal layer is held between a pair of electrode-equipped substrates, is disposed between a first polarizer plate that is located on a light source side and a second polarizer plate that is located on an observation side, a first phase plate is disposed between the first polarizer plate and the liquid crystal cell, a second phase plate is disposed between the second polarizer plate and the liquid crystal cell, and liquid crystal molecules of each of pixels are oriented substantially vertical to a major surface of the substrate in a voltage-off state, the liquid crystal display device comprising:
a circular polarizer structure including the first polarizer plate and the first phase plate;
a variable retarder structure including the liquid crystal cell; and
a circular analyzer structure including the second polarizer plate and the second phase plate,
wherein the light source, the circular polarizer structure, the variable retarder structure and the circular analyzer structure are successively constructed in the named order,
each of the first phase plate and the second phase plate is a uniaxial ¼ wavelength plate that provides a phase difference of ¼ wavelength between light rays with a predetermined wavelength that pass through a fast axis and a slow axis thereof,
the circular polarizer structure includes first compensation means for compensating viewing angle characteristics of a circular polarizer such that emission light from the circular polarizer may become substantially circularly polarized light, regardless of the direction of emission, and
the variable retarder structure includes second compensation means for compensating viewing angle characteristics of a phase difference of the liquid crystal cell.

2. A circular-polarization-based vertical alignment mode liquid crystal display device wherein a dot-matrix liquid crystal cell, in which a liquid crystal layer is held between a pair of electrode-equipped substrates, is disposed between a first polarizer plate that is located on a light source side and a second polarizer plate that is located on an observation side, a first phase plate is disposed between the first polarizer plate and the liquid crystal cell, a second phase plate is disposed between the second polarizer plate and the liquid crystal cell, and liquid crystal molecules of each of pixels are oriented substantially vertical to a major surface of the substrate in a voltage-off state, the liquid crystal display device comprising:
a circular polarizer structure including the first polarizer plate and the first phase plate;
a variable retarder structure including the liquid crystal cell; and
a circular analyzer structure including the second polarizer plate and the second phase plate,
wherein the light source, the circular polarizer structure, the variable retarder structure and the circular analyzer structure are successively constructed in the named order,
each of the first phase plate and the second phase plate is a uniaxial ¼ wavelength plate that provides a phase difference of ¼ wavelength between light rays with a predetermined wavelength that pass through a fast axis and a slow axis thereof,
a third phase plate that has a refractive index anisotropy of nx>ny=nz is disposed between the first polarizer plate and the first phase plate such that a slow axis thereof is set to be substantially parallel to a transmission axis of the first polarizer plate, and
a fourth phase plate that has a refractive index anisotropy of nx=ny>nz is disposed between the liquid crystal cell and the first polarizer plate or the second phase plate.

3. The liquid crystal display device according to claim 1, wherein the liquid crystal cell has a multi-domain vertical alignment mode in which liquid crystal molecules in the pixel are controlled to be oriented in at least two directions in a voltage-on state.

4. The liquid crystal display device according to claim 2, wherein the liquid crystal cell has a multi-domain vertical alignment mode in which liquid crystal molecules in the pixel are controlled to be oriented in at least two directions in a voltage-on state.

5. The liquid crystal display device according to claim 1, wherein in at least half an opening region of each pixel, the orientation direction of liquid crystal molecules in the pixel in a voltage-on state is controlled to become substantially parallel to an absorption axis or a transmission axis of the first polarizer plate.

6. The liquid crystal display device according to claim 2, wherein in at least half an opening region of each pixel, the orientation direction of liquid crystal molecules in the pixel in a voltage-on state is controlled to become substantially parallel to an absorption axis or a transmission axis of the first polarizer plate.

7. The liquid crystal display device according to claim 5, wherein a protrusion for multi-domain control is provided in the pixel.

8. The liquid crystal display device according to claim 6, wherein a protrusion for multi-domain control is provided in the pixel.

9. The liquid crystal display device according to claim 5, wherein a slit for multi-domain control is provided in the electrode.

10. The liquid crystal display device according to claim 6, wherein a slit for multi-domain control is provided in the electrode.

11. The liquid crystal display device according to claim 5, wherein orientation films, which are subjected to an orientation process for multi-domain control, are provided on those surfaces of the two substrates, which sandwich the liquid crystal layer.

12. The liquid crystal display device according to claim 6, wherein orientation films, which are subjected to an orientation process for multi-domain control, are provided on those surfaces of the two substrates, which sandwich the liquid crystal layer.

13. The liquid crystal display device according to claim 2, wherein the fourth phase plate includes a C plate layer that is formed of one of chiral nematic, cholesteric, and discotic liquid crystal polymer.

14. The liquid crystal display device according to claim 13, wherein the fourth phase plate is configured such that the C plate is formed on the second phase plate.

15. The liquid crystal display device according to claim 2, wherein the third phase plate is formed of a resin selected from the group consisting of ARTON resin, polyvinyl alcohol resin, ZEONOR resin, and triacetyl cellulose resin.

16. The liquid crystal display device according to claim 2, wherein the fourth phase plate satisfies the following formula,
Δn(LC)×d(LC)≧{nxy(C)−nz(C)}×d(C)≧Δn(LC)×d(LC)−λ/2
where nxy(C) is an in-plane refractive index, nz(C) is a normal-directional refractive index, d(C) is a thickness, Δn(LC) is a refractive index anisotropy of liquid crystal material of the liquid crystal layer, d(LC) is a thickness of the liquid crystal layer, and λ is the wavelength of incident light to the liquid crystal display device.

17. A liquid crystal display device comprising:
a light source;
a variable retarder structure including a liquid crystal cell in which a liquid crystal layer is sandwiched between a pair of substrates, the liquid crystal cell having a birefringence mode in which a refractive index in a normal direction of the substrate in the liquid crystal layer may be greater than a refractive index in a direction in the plane of the substrate;
a circular polarizer structure that is disposed between the light source and the variable retarder structure and includes a first polarizer plate and a first phase plate that is disposed between the first polarizer plate and the variable retarder structure; and
a circular analyzer structure that is disposed on an observation surface side of the variable retarder structure, which is opposed to the light source, and includes a second polarizer plate and a second phase plate that is disposed between the variable retarder structure and the second polarizer plate,
wherein the circular polarizer structure includes first compensation means for compensating viewing angle characteristics due to the first polarizer plate such that emission light from the circular polarizer structure becomes substantially circularly polarized light, regardless of the direction of emission, and
the variable retarder structure includes second compensation means for compensating viewing angle characteristics of a phase difference of the liquid crystal cell.
